(19) United States
(12) Patent Application Publication
(10) Pub. No.: US 2009/0278347 A1
(43) Pub. Date: Nov. 12, 2009

(54) QUICK CONNECTOR, RELEASE TOOL, AND METHOD THEREFOR

(76) Inventors: Jim Kerin, Gross Pointe Woods, MI (US); Stephen H. Gunderson, Marine City, MI (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(21) Appl. No.: 12/434,224

(22) Filed: May 1, 2009

Related U.S. Application Data
(60) Provisional application No. 61/051,574, filed on May 8, 2008.

(51) Int. Cl. F16L 35/00; B23P 19/04; B23P 11/00

(52) U.S. Cl. 285/39; 29/237; 29/426.6

(57) ABSTRACT

A fluid coupling includes an insertion verifier having a ring and a plurality of forwardly extending legs connected to the ring and disposed in slots defined by side walls of locking arms defined in a retainer. The ring forms an open segment for installation of the ring around a tube. A release tool for disengaging the fluid coupling from a locked to an unlocked position includes a handle forming a gap at a free end thereof between two a semi-cylindrical arcuate members forming a cylindrical release sleeve. The release tool further includes two insertion prongs defining a pocket therebetween. The release sleeve is adapted to disengage the retainer, and the pocket is adapted to disengage the verifier of the fluid coupling.

### CROSS-REFERENCE TO RELATED APPLICATIONS

This patent application claims the benefit of U.S. Provisional Patent Application No. 61/051,574, filed May 8, 2008, which is incorporated herein in its entirety by reference.

### BACKGROUND OF THE INVENTION

This application relates to quick connector coupling assemblies for fluid systems, and more particularly to a quick connector for high pressure applications that releasably connects a male member formed at the end of a hollow tube to a hollow connector body, as well as to a release tool therefor.

In the automotive and other fields, a quick connector coupling assembly is often utilized to provide a fluid connection between two components or conduits which generally include a male member, or tube, received and retained in a female connector body. Use of a quick connector is advantageous in that a sealed and secure fluid line may be established with minimum amount of time and expense. Most quick connector assemblies are also serviceable, insofar as each joint may be disconnected and later rejoined, and are often subjected to various manufacturing processes, such as tube bending operations, before being installed into a product assembly.

A retainer is often used to secure the male member within the connector body. One such type of retainer includes a plurality of locking members which extend between a radially enlarged upset formed on the male member and an annular face defined in the connector body. The abutment of the retainer with the upset of the male member at one end and the annular face of the connector body at the other end prevents the withdrawal of the male member from the connector body. This type of retainer is prevalent in the art and has proven effective in many fluid line applications.

A seal member, usually in the form of an O-ring seal, is used with a quick connector coupling to create a fluid tight seal between the male member and the connector body. In such a configuration, the O-ring is located axially inwardly of the retainer and separated by an annular spacer slidably mounted on the male member. It is often held against axial load imparted by fluid pressure by a spacer that is press fit, or in a snap fit relation to the bore in which it is received. Since the retainer is somewhat flexible, and the O-ring is slidably linked with the retainer, the O-ring is able to slide slightly relative to the male member. Also, such quick connector assemblies are often used in applications where the components are subject to high temperature or pressure, as well as vibration and cyclic application of pressure. These conditions increase the difficulty of maintaining a fluid tight joint. In high pressure applications such as automotive brake systems, it is necessary to ensure that the axial force imparted to the components be reliably accommodated.

Other known arrangements incorporate a sleeve arrangement to transfer axial load imparted to the seal ring by fluid pressure to the retainer through the upset formed on the male member or tube. In one embodiment, an additional spacer made of Teflon polymer located between the seal member and the sleeve is also used to minimize the effects of vibration and cyclic load.

An improved sleeve or outer spacer may be configured to transfer axial load imparted by the O-ring seal directly to the locking arms of the retainer. This quick connector coupling includes an insertion verifier/latch that serves the functions of providing verification of the complete insertion of the male member into the body of the connector assembly, and also provides a latching function to stabilize the locking arms of the tube retainer to suppress inward movement and increase overall burst pressure performance. The insertion verifier/latch also serves to close the entrance into the connector body to minimize entry of contaminants. A release tool to disconnect such a coupling is provided. It is arranged to implement removal of the insertion verifier/latch component and also displace the locking arms of the primary retainer to permit withdrawal of the male member from the body component. Release tools to decouple the male member are known for example from U.S. Pat. No. 4,927,185, the content of the specification and drawings of which are hereby incorporated by reference herein.

This application farther relates to a removal tool for removing or disengaging components of a fluid coupling. Typical fluid couplings include retainers and other components that secure a male tube into a component, which may include abutting relationships between locking tabs with portions of the tube. Most connectors are designed for quick assembly, but disassembly of such couplings can be difficult, cumbersome, or may even cause damage to the coupling requiring its replacement.

### BRIEF SUMMARY OF THE INVENTION

The invention provides, in one aspect, a release tool for disengaging a quick connector assembly from a locked position into an unlocked position. The release tool includes a handle having a generally elongate U-shape defining two handle beams joined at a first end by a flexure portion. The release tool forms a gap at a second end thereof which is opposite the flexure portion, between two semi-cylindrical arcuate members. Each semi-cylindrical arcuate member is disposed adjacent the second or free end of each handle beam, and together the two arcuate members form a generally cylindrical release sleeve when the release tool is in a closed position. The release sleeve is bifurcated by the gap when the release tool is in an open position. The release tool further includes two insertion prongs. One insertion prong is disposed at the second end of each of the two handle beams. The two insertion prongs extend parallel to one another when the release tool is in the closed position and define a pocket therebetween.

In another aspect, the disclosure describes a method for disassembling a quick connector coupling fluidly connecting a male tubular member forming an upset with a bore formed in a component. The quick connector coupling includes a retainer having locking legs disposed in the bore and extending radially inwardly toward the male tubular member in abutting relationship with the upset. The method includes inserting segments of a release sleeve formed on the release tool around a segment of the male tubular member. The release sleeve is generally cylindrical and has a free end disposed toward the upset of the male tubular member when the release sleeve is inserted around the male tubular member. The release tool is moved axially along the male tubular member such that at least a portion of the release sleeve enters into the bore and contacts the locking legs. The locking legs are deformed in a radially outward direction relative to the bore by application of a force in the axial direction on the release tool. The male tubular member is removed from the bore after the locking legs have been deformed to an extent that the abutting relationship between the locking legs and the upset has been overcome, and the release tool is removed from the bore to complete the disassembly.

In yet another aspect, the disclosure describes a fluid coupling assembly associated with a tube forming an upset close to an end thereof. The fluid coupling assembly includes a connector body defining a bore extending axially from an entrance opening defined by a radially inward extending rim. The bore has a retainer receiving portion adjacent the rim and a sealing member receiving portion forward of the retainer receiving portion. A retainer is releasably secured to the connector body and includes a plurality of axially extending locking arms extending into the retainer receiving portion of the bore. Each of the plurality of axially extending arms includes a rearward abutment surface in abutting relation with the rim, and a forward abutment surface adapted to abut the upset of the tube. The fluid coupling assembly further includes an insertion verifier. The insertion verifier has a ring and a plurality of forwardly extending legs connected to the ring and disposed in the slots defined by the side walls of the locking arms when the insertion verifier is in a locked position relative to the retainer. A radially outwardly directed pad formed on at least one of the forwardly extending legs and having a rearward end defining a latching surface releasably engages an end of one of the slots. An open segment extends through the ring between two adjacent legs and is adapted to accommodate installation of the ring around the tube.

### BRIEF DESCRIPTION OF THE SEVERAL VIEWS OF THE DRAWINGS

FIG. 1 is a side sectional view of a quick connector coupling assembly with the tube releasably connected to the body component and the connection verifier positioned on the tube rearward of the tube upset.

FIG. 2 is a sectional side view of the coupling receiving bore in the system component of the quick connector coupling assembly of FIG. 1.

FIG. 3 is a side view of the retainer.

FIG. 4 is a plan view of the forward end of the retainer of FIG. 3.

FIG. 5 is a side sectional view of the retainer of FIG. 3 taken along the line 5-5 of FIG. 4.

FIG. 6 is a plan view of the rearward end of the retainer of FIG. 3 rotated forty-five degrees (45°) relative to FIG. 4.

FIG. 7 is a side view of the retainer of FIG. 6.

FIG. 8 is a plan view of the rearward end of the insertion verifier.

FIG. 9 is a side view of the insertion verifier of FIG. 8.

FIG. 10 is a side view of the insertion verifier of FIG. 8 rotated forty-five degrees (45°) relative to FIG. 9.

FIG. 11 is a plan view of the forward end of the insertion verifier of FIG. 8.

FIG. 12 is a side sectional view of the insertion verifier of FIG. 8 taken along the line 12-12 of FIG. 11.

FIG. 13 is an end view of the outer spacer or sleeve of the quick connector coupling showing the rearward end.

FIG. 14 is a side sectional view of the outer spacer of FIG. 13.

FIG. 15 is a perspective view, in fully assembled relation, of the tube retainer and insertion verifier.

FIG. 16 is a side perspective of a modified form of the tube retainer and insertion verifier components of the quick connector coupling assembly.

FIG. 17 is a side view of the insertion verifier of the assembly of FIG. 16.

FIG. 18 is a perspective view of an alternative embodiment of an insertion verifier in accordance with the disclosure.

FIG. 19 is an end view of the alternative embodiment of the insertion verifier of FIG. 18.

FIG. 20 is an outline view of a release tool in accordance with the disclosure, and FIG. 20a is a detail section thereof.

FIG. 21 is a detail view of the release tool shown in FIG. 20.

FIGS. 22 and 23 are outline views of a release tool during and after disengagement of an insertion verifier in accordance with the disclosure.

FIG. 24 is an outline view of a release tool during disengagement of a retainer in accordance with the disclosure.

### DETAILED DESCRIPTION OF THE INVENTION

The fluid coupling assembly 410 and various components thereof as illustrated in the several views of the drawings is part of a fluid system and forms a joint between a hollow tube 420 and a fluid system component 414 in fluid tight relation. The tube 420 defines a male member 412 which includes a radially directed annular upset 422 spaced from the free end of the tube. The male member includes an outer cylindrical sealing surface 424 between the tube end and the upset 422. A cylindrical surface 425 of the tube 420 extends rearward of upset 422.

The coupling assembly includes a retainer 416, a sealing member 418, an inner spacer 415, and an outer spacer or cylinder 417. These components releasably secure the tube male member 412 to a component 414 in a fluid tight relation. Even though the component 414 is illustrated as an “ABS unit” of an automotive brake system, such component may alternatively be a master cylinder, brake caliper, or other high or low pressure system component.

As seen in FIG. 2, the component 414 defines a tube, seal, and retainer receiving bore 430. In the illustrated embodiment, the bore 430 is divided into four portions, a retainer receiving portion 449, a sleeve or cylinder receiving portion 447, a seal receiving portion 450, and a reduced diameter tube receiving portion 451. Each portion extends axially forward from an entrance opening 432. The reduced diameter tube receiving portion 451 is fluidly connected to a fluid passage formed in the component 414.

The entrance opening 432 is defined by an annular flange or rim 440 defining an axial cylindrical surface 436 around the opening 432. A forward facing locking surface 438 extends radially inward from the locking surface 438 toward the retainer receiving portion 449. The sleeve receiving portion 447 includes a cylindrical wall 448 of a diameter larger than the cylindrical wall 444 defining the seal receiving portion 450 of the bore and smaller than the diameter of the cylindrical wall 442 defining the retainer receiving portion 449 of the bore 430. A conical surface 459 extends between a wall 448 of the sleeve receiving portion 447 and the wall 444 of the seal receiving portion 450.

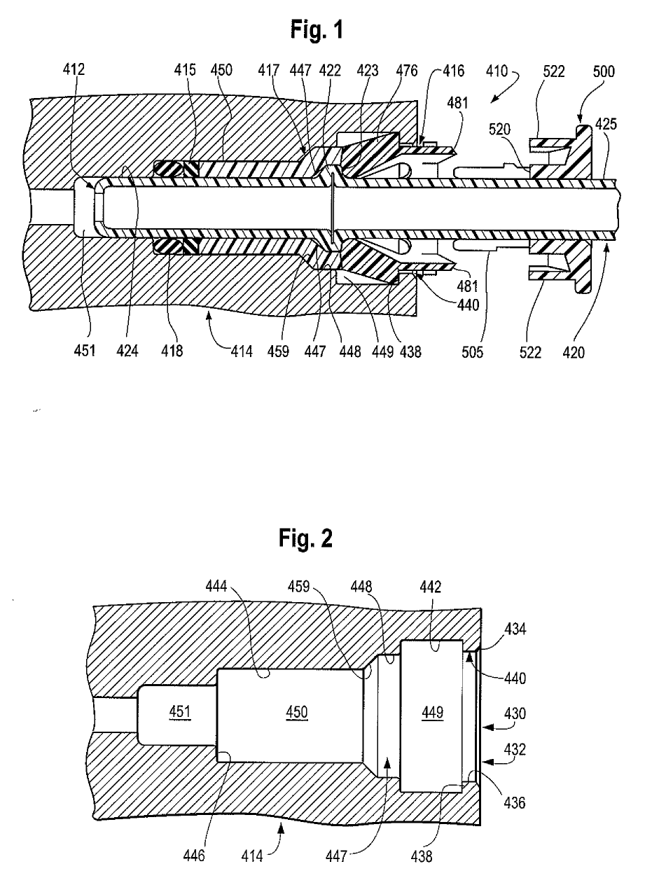

A cross section of the quick connector coupling assembly is shown in FIG. 1. The cylindrical sealing surface 424 of the male member 412 of tube 420 is positioned in the tube receiving portion 451 of bore 430. The retainer 416 is connected to the annular flange or rim 440 at the entrance opening with locking arms 476 formed on the retainer 416 and extending between the radial abutment surface 438 and the upset 422 formed on the tube 420 to releasably retain the male member 412 within the component 414.

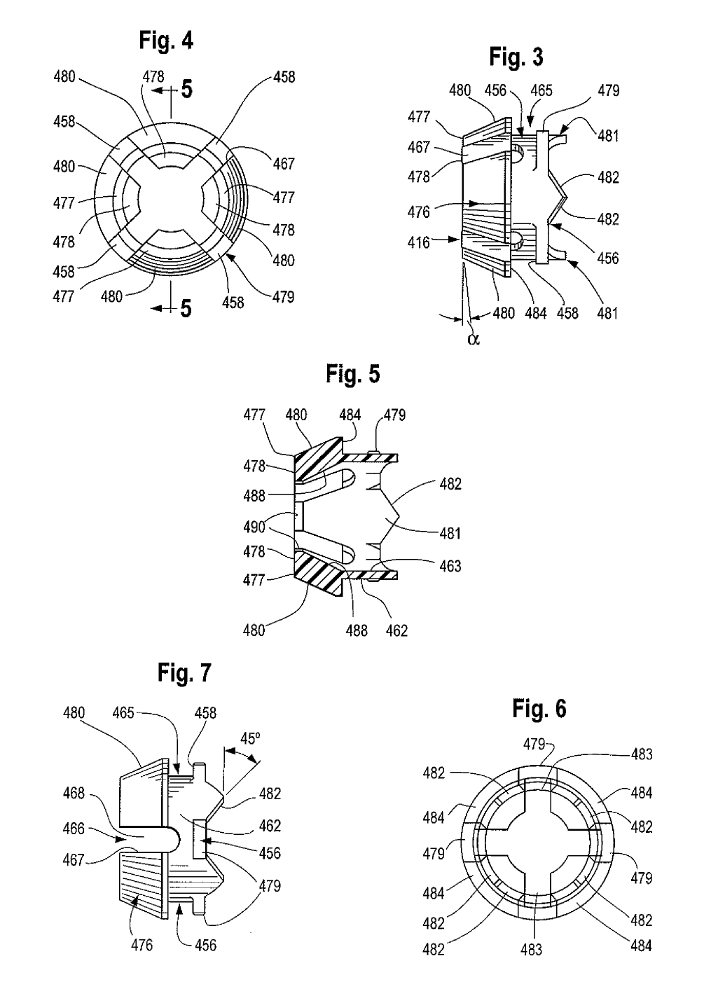

The retainer 416 is best seen in FIGS. 3-7. The retainer 416 includes a cylindrical ring 456 having an outer cylindrical surface 462 and an inner cylindrical surface 463. An outer diameter of the outer cylindrical surface 462 is smaller than the inner diameter of the cylindrical surface 436 of the entrance opening 432 of the component 414 such that the retainer 416 is loosely piloted in the component 414. The inner diameter 463 of ring 440 is larger than the outer diameter of the upset 422 formed on the hollow tube 420 to permit insertion of the tube 420 during installation.

Four slots 466 are formed between the locking arms 476, as is best shown in FIG. 7. The slots 466 are defined by axially extending side faces 467 of the locking arms 476, are open on one end, and terminate at curved end surfaces 468. Each locking arm 476 forms a generally radially extending forward abutment surface 478 that abuts the tube upset 422, and a rearward abutment surface 484 that abuts the locking surface 438 (FIG. 1) of rim 440 when the retainer 416 is installed into the component 414. Each locking arm 476 further defines an outer ramped surface 480, an inner ramped surface 488, and an inner cylindrical surface 490.

During installation of the male member 412 of the tube 420 into the entrance opening 432, the upset 422 contacts the interior ramped surfaces 488 and deflects the locking arms 476 radially outward to permit passage of the upset forward, beyond the front abutment surfaces 478. When the tube is fully inserted, the upset resides forward of the locking arms 478 and the arms return to their normal position with cylindrical bottom surfaces 490 overlying an outer cylindrical surface 425 of the male member 412, which is disposed rearward of the upset 422. When the male member 412 is fully inserted, the forward abutment surfaces 478 abut the upset 422.

In the illustrated embodiment, the arms 476 also include angled arcuate abutment surfaces 477 or chamfers between the forward abutment surfaces 478 and the outer ramped surfaces 480. These angled abutment surfaces 477 are angled in a rearward direction toward ring 456 at an angle α, of five to thirty degrees (5° to 30°) to a plane perpendicular to the longitudinal axis of the retainer 416, and may aid in insertion of the retainer 416 into the component 414. Four radial protrusions 479 are formed at the rearward end of the ring 456, as is best illustrated in FIG. 7, each having a chamfer 483 formed along the inner cylindrical surface 463 used to guide the insertion verifier as described below. Intermediate each protrusion 479 is a rearwardly directed guide element 481 defined by two angled surfaces 482 formed at an angle of forty-five degrees (45°) to a plane perpendicular to the longitudinal axis of the retainer 416. The surfaces are thus ninety degrees (90°) to each other, meet at a central apex, and are chamfered to diverge in the forward direction.

Forward faces 458 on protrusions 479 define a channel 465 with the rear abutment surfaces 484. The retainer axial forward movement is limited by the forward faces 458. Channel 465 is sized to receive the rim 440 of the component 414. The cylindrical surface 436 of the body component overlies the outer cylindrical surface 462. When assembled to the body, the rim or flange 440 of the body resides radially outward of cylindrical surface 462 of ring 456. The rear abutment surfaces 484 of locking arms 476 abut the radial annular abutment surface 438 of the component 414 and deliver axial loads from fluid pressure to the radial surface 438 of the component 414.

A seal pack, including a seal member in the form of an O-ring seal 418, surrounds the cylindrical surface 424 of the tube 420 and seals to the component 414 in the seal receiving portion 450 of bore 430. Inner spacer 415 is positioned rearward of the O-ring 418.

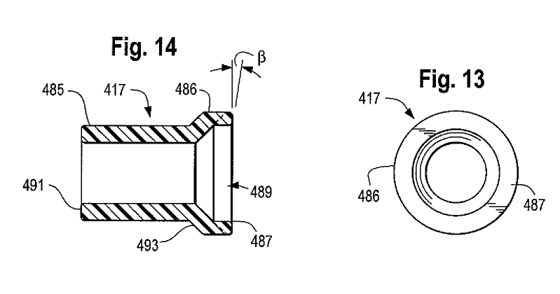

The outer spacer 417 (FIG. 1) is positioned between the forward abutment surfaces 478 of the locking arms 476 and the inner spacer 415. Best seen in FIGS. 13 and 14, the outer spacer 417 is hollow and includes a forward small cylinder portion 485 and a rearward large cylinder portion 486. The large cylinder portion 486 includes a rearward conical annular surface 487 angled to diverge radially and rearward toward the locking arms 478 of retainer 416. The angle β of the surface 487 is five to thirty degrees (5° to 30°) to a plane perpendicular to the longitudinal axis of the cylindrical portions 485 and 486 and is complimentary with the angled surfaces 477 of locking arms 476. The rearward large cylinder portion 486 defines a tube upset pocket 489. As seen in FIG. 1, when the coupling is assembled, the upset 422 of the tube 420 resides in the tube upset pocket 489. That is, the inner diameter of the large cylinder portion 486 is larger than the outer diameter of the upset 422.

In the assemblage shown in FIG. 1, the small cylinder portion 485 resides in the seal receiving portion 450 and the large cylinder portion 486 resides in the sleeve or cylinder receiving portion 447 of the bore 430. The outer spacer 417 slides into the cavity or bore 430 of the component 414 with the small cylinder portion received in the seal receiving portion 450 and the large cylinder portion received in the sleeve receiving portion 447. Use of the outer spacer 417 prevents dislocation of the seal pack when the male member 420 is removed.

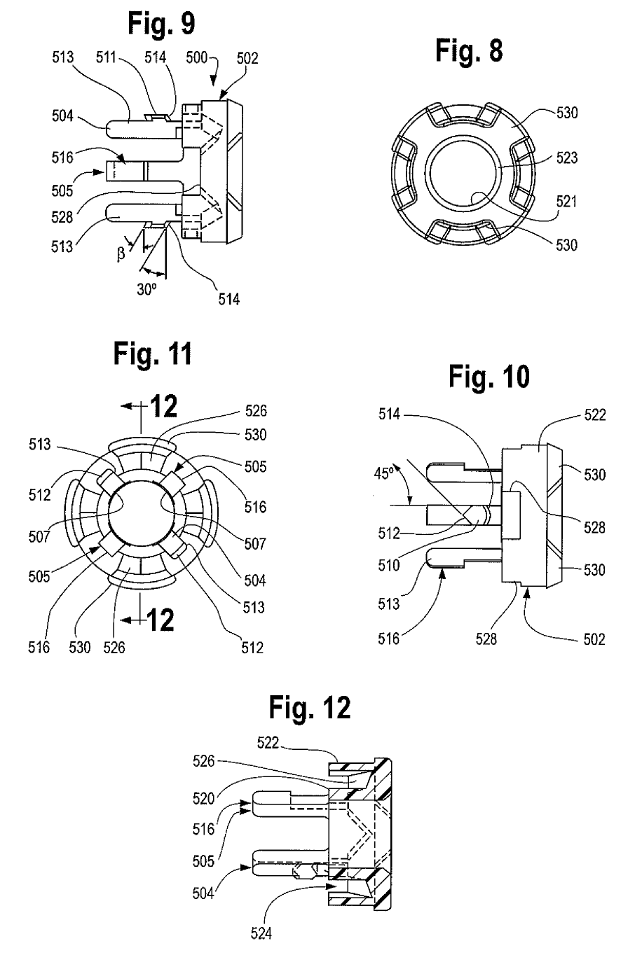

The quick connector coupling also includes an insertion verifier 500 shown in detail in FIGS. 8-12. It functions somewhat similarly to the secondary latch disclosed in U.S. Pat. No. 6,173,994 in that it includes legs that slide into the slots between the locking arms of the retainer. The legs are sized such that the insertion verifier can only be fully inserted if the tube upset is fully inserted and latched, forward of the forward abutment surfaces 478 of the retainer locking arms 476.

The insertion verifier 500 includes ring 502 having radially inner annular axial wall 520 and a radially outer annular axial wall 522 connected by a rearward radial wall. The radially inner wall 520 has an inner surface 521 having a diameter slightly larger than the outer cylindrical surface 425 of male member 412 to permit it to slide axially on the tube 420.

The radially outer annular wall 522 defines, with wall 520, a hollow annular space 524. The rearward most terminus of the annular space 524 is defined by angled wall surfaces 526 that are complementary to the angled surfaces 482 of guide elements 481. That is, the wall surfaces 526 are at an angle of ninety degrees (90°) to each other and at an angle of forty-five degrees (45°) to a plane perpendicular to the longitudinal axis of the insertion verifier.

The angled wall surfaces 526 define four pockets to receive the four guide elements 481. The rearward end of retainer ring 456 resides in the annular space 524 when the guide members 481 are disposed in the pockets formed by wall surfaces 526. Outer annular wall 522 includes four notches 528 to receive the radial protrusions 479 that are extant at the rearward end of the retainer ring 456.

Four radial lips 530 extend from rearward end of outer wall 522. These lips are useful in manually retracting the insertion verifier from its inserted position. The insertion verifier 500 further includes four axially extending legs, two legs 504 and two legs 505, extending forward of the wall 520 of ring 502. The two legs 504 are spaced one hundred eighty degrees (180°) apart, and the two legs 505 are spaced one hundred eighty degrees (180°) apart. These pairs of legs are equally spaced about ring 502. The radially inner-arcuate surfaces 507 of the legs are formed on about the same diameter as the inner diameter of inner surface 521 of inner wall 520 of ring 502 and thus slide freely on cylindrical surface 425 of tube male member 412.

The legs 504 and 505 include radially directed axially extending side walls 513 and have a lateral or circumferential width sized to fit into the slots 466 between the side faces 467 of the locking arms 476 of the retainer 416. Such positioning is possible only when the male member 412 is fully inserted into the coupling body cavity or bore 430, with the tube upset 422 disposed forward of the forward abutment surfaces 478 of the locking arms 476 in the upset pocket 489 defined by the large diameter portion 486 of the sleeve or outer spacer 417. When so positioned, the legs 504 and 505 can be fully inserted axially between the locking arms 476 because axial forward movement is limited by the position of the upset 422. The interrelationship between the legs 504 and 505 and locking arms 476 is best seen in FIG. 16. There, the legs 504 and 505 of the insertion verifier 500 are fully inserted into the slots between the retainer locking arms 476.

The two legs 504 include radially outwardly directed pads 510, each of which includes a forward rotational guide 511. Each guide 511 is defined by two guide surfaces 512 that forwardly converge and meet at an apex, which is disposed mid-way between the side walls 513 of the legs 504, and extend rearwardly from the point at an angle of forty five degrees (45°) to the axial side walls 513 of the legs 504, i.e. ninety degrees (90°) to each other. The guide surfaces 512 have a forward pitch or angle β to be complementary to the chamfers on the guide surfaces 482 on the guide elements 481. On axial insertion of the insertion verifier along tube 420, contact of the guide surfaces 512 with angled surfaces 482 of guide elements 481 results in rotation of the retainer 416 to align legs 504 and 505 of insertion verifier with chamfers 483 to align the legs with slots 466 and permit the legs to pass into the slots 466 between the side surfaces 467 of locking arms 476.

The rearward end of each pad 510 includes a latching surface 514. On full insertion of legs 504 between locking arms 476, the latching surfaces 514 catch the end surfaces 468 defining the rearward terminus of the slots 466 to releasably secure the verifier 500 to the retainer 416. These latching surfaces are sloped rearward and are arranged to catch on surfaces 468 to hold the verifier 500 in the assembled coupling. The slope of the latching surfaces 514, for example, of thirty degrees (30°) relative to a plane perpendicular to the longitudinal axis of the verifier 500, permits these surfaces to be unlatched when a force is applied to pull the verifier axially rearward.

Each of the other two legs 505 of the verifier 500, those not provided with pads 510, includes a radially extending block portion 516. The block portions 516 on legs 505 are located adjacent the distal ends of the legs and extend rearwardly and terminate at about the same axial position as the point formed by guide surfaces 512 on pads 510 of legs 504. This block portion adds bulk to the legs and fills the volume of the slot 466, into which each leg 505 is inserted, to further enhance the latching strength of the assemblage. The added mass of legs 505 provided by blocks 516 aids in insertion of the tube male member 412 into bore 430 when the insertion verifier 500 is employed for that function by applying axial force to the verifier ring 502.

In one embodiment, the radial thickness of the legs 505 at blocks 516 is about the same as the radial thickness of legs 504 rearward and forward of the pads 510. At the pads 510, the radial thickness of legs 504 exceeds the radial thickness of the legs 505 at blocks 516. The pads 510 on legs 504 are located about midway between the distal end of the leg and its connection to annular ring 502. The radial thickness of legs 505 between blocks 516 and the connection of legs 505 to inner annular wall 520 is about half the radial thickness of the legs 504, or the thickness of the legs 505 at blocks 516. Thus, the outer surface of the legs 505 between the blocks 516 and the connection to annular wall 520 creates a cavity or cutout to permit deflection of the annular ring 456 of retainer 416 radially inwardly during insertion and removal of the legs 504 and 505 of insertion verifier 500.

The insertion verifier 500 is assembled by sliding axially along the tube 420 so the guide surfaces 512 of pads 510 contact the retainer guide elements 481 creating a rotation of the retainer 416 that aligns the legs 504 and 505 with the slots 466. During assembly, the insertion verifier pads 510 expand, or deform the annular ring 456 of the retainer 416 outward until the rear latching surfaces 514 move past the forward surfaces 468 between the retainer locking arms 476 and lock in place. At the same time, the retainer ring 456 may bow inward by about ninety degrees (90°) during insertion. As previously described, the relative thickness of the legs 505 between the blocks 516 and connection of the legs to inner annular wall 520 permits such radially inward distortion of retainer ring 456.

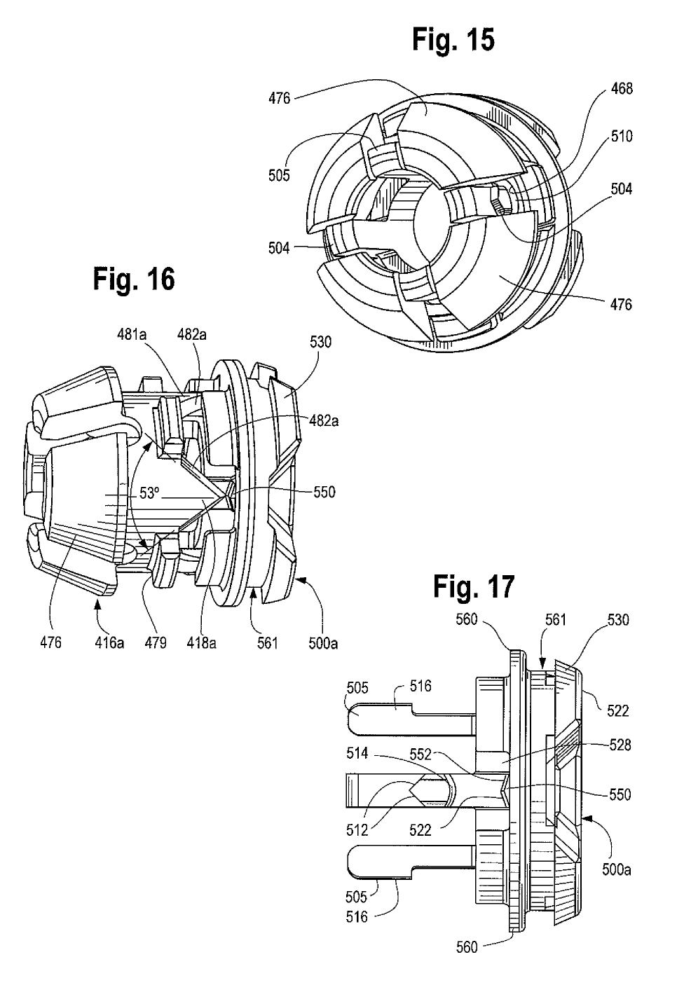

The assembled relationship of verifier and retainer is best illustrated in FIGS. 15 and 16. The legs 504 and 505 of verifier 500 prevent the locking arms 476 from flexing radially inward, thus adding to the overall resistance to unintentional unlatching of the retainer 416 from rim 440 of the bore 430.

The length and width of the four insertion verifier legs 504 and 505 are selected such that the legs fit in slots 466 between side faces 467 of retainer locking arms 476. When so positioned, the legs 504 and 505 contact the tube upset and propel the tube upset past the retainer locking arms before the latching surfaces 514 latch onto surfaces 468 in slots 466 of retainer 416. Full insertion of the tube end is accomplished by axially moving the verifier 500 forward.

The legs 504 and 505 contact upset 422 and urge it beyond the retainer locking arms with the forward locking surfaces 478 disposed in abutting relation to the upset 422. The upset resides in the upset pocket 489 formed by the large diameter cylinder portion 486 of outer spacer 417. The legs 504 and 505 of the verifier 500 reside in slots 466 with latching surfaces 514 latched to rearward surfaces 468 of retainer 416. With insertion verifier fully locked into the retainer, the primary latching of tube upset to retainer may be guaranteed. Moreover, the close fit between the verifier and the retainer prevents debris from entering the connector. When disconnected during service, verifier radial lips 530 are formed on the outside diameter that can be gripped manually to pull the insertion verifier rearward axially along tube 420 and out of the retainer 416. The ring 456 of retainer 416 will deform at the two contacts with the pads 510 radially outward at two places one hundred eighty degrees (180°) apart. Such deformation permits the latching surfaces 514 to disengage from the surfaces 468 and permit withdrawal of the retainer legs 504 and 505 from slots 466.

An alternate embodiment of a guide element 481a is illustrated in FIG. 16. The angled surfaces 482a of each guide element 481a are at a greater angle relative to one another, here 53°. This relationship results in the guide elements 481a being longer in the axial direction than the guide elements 481 of FIGS. 1-14. The guide surfaces 482a thus impart a greater relative rotational component to the insertion verifier 500a on insertion into the retainer.

Best seen in FIG. 17, an alternate embodiment of an insertion verifier 500a is shown. The insertion verifier 500a includes a forwardly directed guide element 550 aligned with each of the legs 504 and 505. The guide element 550 is formed by two angled surfaces 552 at an angle of about 12.5° relative to a plane perpendicular to the axial extent of a verifier 500a. These surfaces are positioned in alignment with the legs and may impart a relative rotational force component to the insertion verifier when the legs 504 and 505 are not aligned with the slots 466 of the retainer 416 and the guide elements 481 of the guide elements 481 override the guide surfaces 512 on pads 510.

The guide element 550 acts to align the legs 504 and 505 with the locking arms 476 during insertion of the verifier. The legs contact the interior ramped surfaces 488 and urge the free ends of the locking arms radially outwardly, away from the tube surface 425. The axial length of guide elements 550 is such that the apex of each guide element contacts the rearward radial annular wall before the legs 504 and 505 lift the locking arms 476 sufficiently to permit passage of the upset 422 rearwardly. This relationship prevents the misaligned insertion verifier from inadvertently releasing the tube from the assembly.

Insertion verifier 500a also includes a radial outwardly directed rim 560 immediately rearward of notches 528 in outer annular wall 522. Rim 560 defines a slot 561 with the radial lips 530 of verifier/latch 500a. This rim deters attempts to remove the insertion verifier with a tool not intended for that purpose. When the insertion verifier 500a is inserted into a coupling assembly the rim 560 is spaced from the surface at entrance opening of bore 430 in component 414, in overlying relation to radial protrusions 479 of retainer 416. This relationship deters use of tools such as wrenches to remove the insertion verifier.

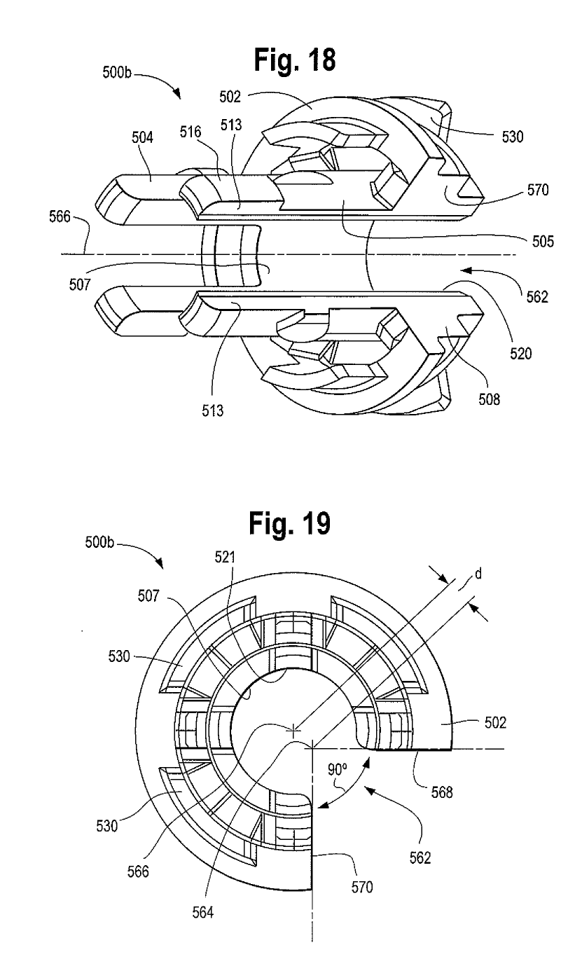

An alternative embodiment of an insertion verifier 500b is shown in FIGS. 18 and 19. In the description of FIGS. 18 and 19, like or similar components and features of the insertion verifier 500b that are the same or similar to like components and features of the embodiments for the insertion verifier 500 or 500a previously described are denoted by the same reference numerals as previously used for simplicity. The insertion verifier 500b is arranged to cooperate with the retainer 416 shown in FIGS. 4-6, or other similar retainers. The insertion verifier 500b includes four legs, 504 and 505, which are connected to the annular ring 502 and which operate to retain and maintain the locked condition between the male member 420 and the component 414 and retainer 416, as shown in FIG. 1.

In this alternative embodiment, the annular ring 502 includes a cutout or open segment 562, as is best seen in FIG. 19. The open segment 562 is formed through an entire thickness of the annular ring 502 and extends angularly over an entire segment between two adjacent legs 504 and 505, resulting in the annular ring 502 being generally C-shaped. In the illustrated embodiment, the open segment 562 spans over a 90 degree segment of a circle having a center point 564 that is displaced by a distance, d, from a center point or central axis 566 of the radially inner-arcuate surfaces 507 of the legs 504 and 505, which, as previously described, are formed on about the same diameter as the inner diameter of inner surface 521 of inner wall 520 of ring 502. In this arrangement, two radially extending surfaces 568 and 570 are defined in the annular ring 502 on either side of the open segment 562. The two radially extending surfaces 568 and 570 are arranged to coincide or be coplanar with the radially directed axially extending side walls 513 of the legs 504 and 505, as best shown in FIG. 18.

The insertion verifier 500b is advantageously capable of operating in much the same fashion as the insertion verifiers 500 and 500a previously described insofar as the legs 504 and 505 operate to securely retain engagement between the male member 420 and the component 414 when the retainer 416 has been installed and the insertion verifier 500, 500a, or 500b has been inserted. However, the insertion verifier 500b is advantageously further capable of being insertable and removable from the male member 420 without requiring sliding over an open end of the tube. In other words, the open segment 562 enables insertion of the insertion verifier 500b over any segment of a tube having an outer diameter that is at most equal to the inner diameter the inner surface 521 of inner wall 520 of the ring 502.

An additional advantage to the generally C-shaped annular ring 502 is the ability of using bending equipment for forming a bend in a tube in areas overlapping the position of the insertion verifier 500b when installed on the tube. For example, the tube 420 may form an arcuate section or bend around a bending tool, which may overlap with a retainer section of the tube 420 having the insertion verifier 500b installed thereon. Such relative positioning is possible because the insertion verifier 500b may be oriented onto the tube such that the open segment 562 thereof accommodates the bending tool.

Additional advantages of the insertion verifier 500b having the open segment 562 formed therein, which enables insertion and removal of the insertion verifier 500b onto any segment of a tube, can be readily appreciated. For example, where in previous designs installation of an insertion verifier (500 or 500a) required an open end in the tube, which meant installation of such verifiers before subsequent finishing operations of the ends of the tubes could be performed, the manufacturing process of a tube assembly using a insertion verifier 500b may be much simplified insofar as the insertion verifier 500b may be assembled at any time. Moreover, damaged or worn insertion verifiers may be replaced in the field or during service without having to rework any portions of the tubes they are installed on for the purposes of removing or installing the insertion verifier.

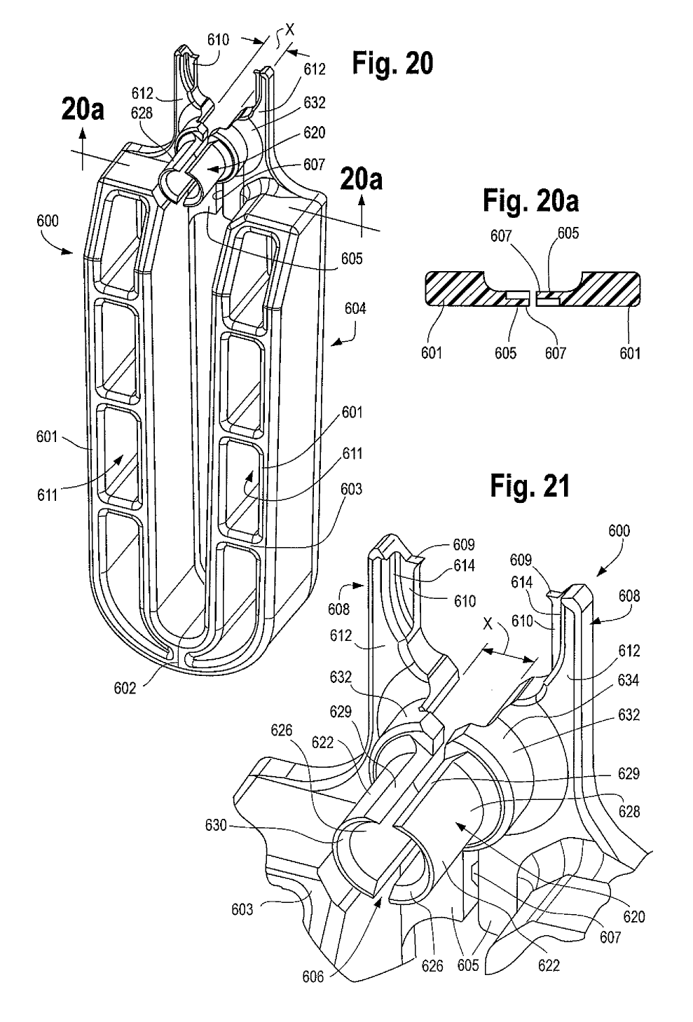

Referring to FIGS. 20, 20a, and 21, there is shown a release tool 600 useful to disassemble quick connector couplings, for example, the quick connector coupling of FIG. 1 or other similar couplings. The tool 600 is configured to implement dislodgement of insertion verifier 500, 500a, or 500b from its releasable connection to retainer 416 such that it may be slid axially along tube 420 to a position spaced from retainer 416 as depicted in FIG. 1. The tool 600 may additionally be employed to spread the retainer locking arms 476 radially outwardly, sufficiently to move upset 422 of male member 412 axially rearward of abutment surfaces 478. Removal of the male member 412 and release tool 600 permits the locking arms 476 to return to their normal position, ready to receive a reinserted tube 420 with upset 422.

Release tool 600 is a hand tool usable to manually disassemble the quick connector coupling. It is particularly suitable for use with an insertion verifier, such as the verifiers 500, 500a, and 500b as described thus far. It should be understood, however, that the latch verifier need not be configured exactly as depicted by verifier 500, 500a, or 500b. It is only necessary that the verifier includes radial lips such as lips 530 as shown on each of the presented embodiments for insertion verifiers 500, 500a, and 500b.

Further, the coupling need not employ an insertion verifier latch. A simple dust cap that is of an external structure similar to the exposed portions of the insertion verifier 500, 500a, or 550b can be used to protect the entrance opening 432 from entry of dirt and other contaminants. The dust cap would include elements that releasably secure it in surrounding relation to tube 420 and in overlying relation to entrance opening 432. Provision of radial lips such as lips 530 render the verifier latch suitable for disengagement from its releasably secured position protecting entrance opening 432.

Similarly, the particular configuration of retainer 416 as disclosed is not significant to the utility of the release tool. It is only necessary that the retainer includes locking arms such as arms 476 which have abutment surfaces 478 to abut the forward-facing surface of upset 422 and which are displaceable radially outward away from surface 425 of tube 420 to permit withdrawal of upset 422 rearwardly.

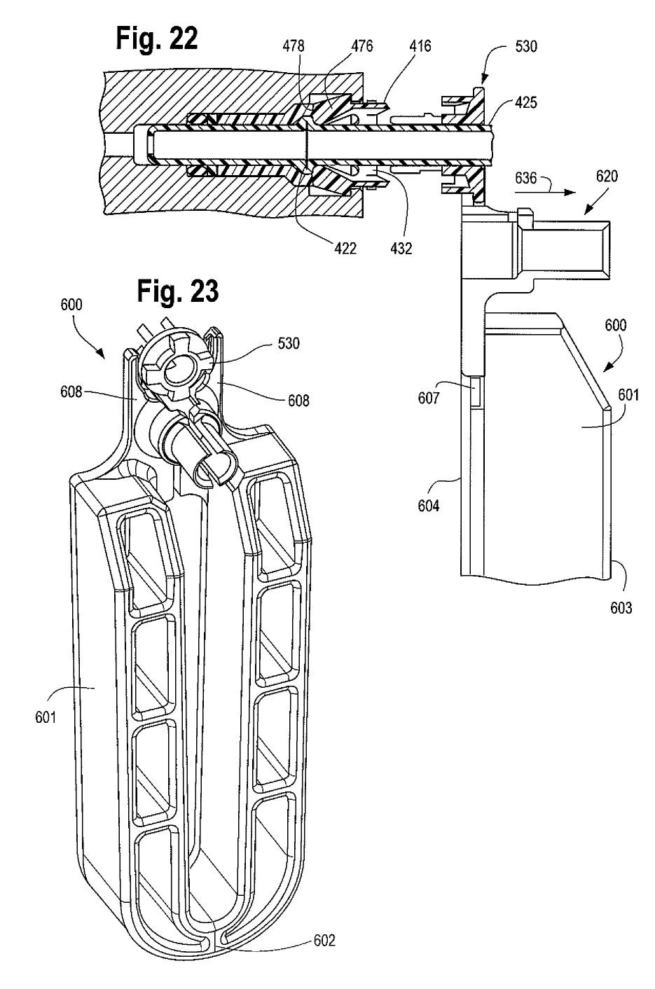

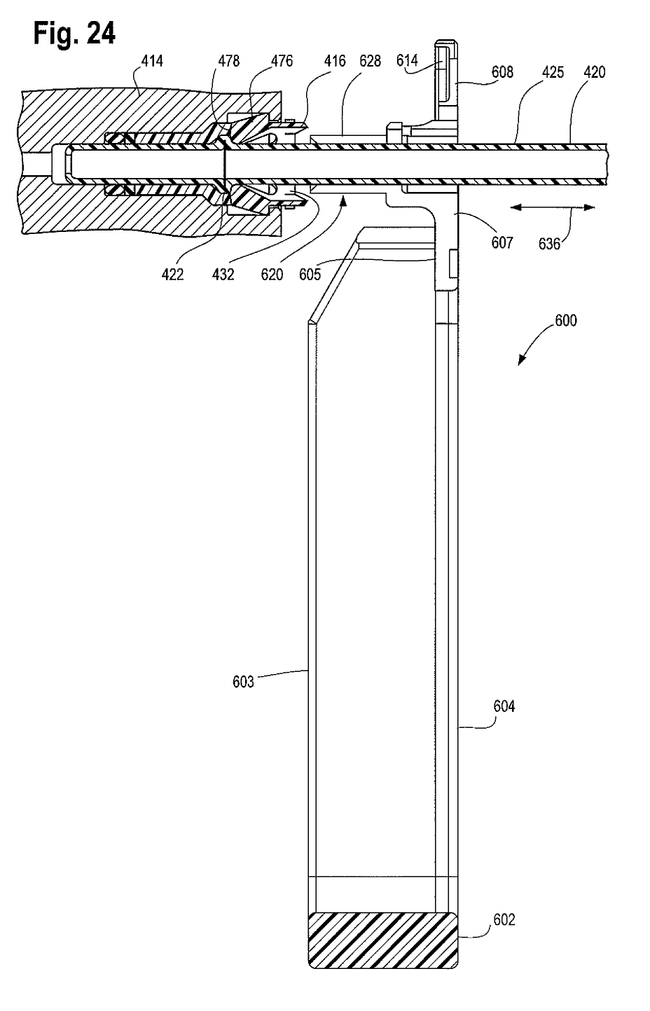

Release tool 600 is longitudinally elongate with a U-shaped handle defined by handle beams 601 connected by a joining flexure portion 602. The handle beams define planar surfaces 603 and 604 deemed front and rear surfaces in reference to FIGS. 22 and 24. The handle portions may include depressions 611 extending from the front surface 603 toward the rear surface 604, or depressions extending inward from both surfaces, particularly if the tool 600 is injection molded. The particular makeup of the handle beams is not important to its function.

The distal ends of the handle beams 601 each include a generally planar platform 605 adjacent rear surface 604. Platforms 605 are separated by a longitudinal space or gap 606. In one embodiment, each one of the platforms 605 is provided with a protrusion 607 that contacts the side of the other platform to maintain the uniformity of the gap 606. In the illustrated embodiment, the protrusions 607 on each of the platforms 605 are offset such that each protrusion 607 of each platform 605 contacts the side of the other platform 605, as best shown in FIG. 20a. In other words, even though the handle beams may be spread apart to increase the width of the gap 606, deflection of the beams toward each other is limited by contact of protrusion 607 with the other platform at a position where the handle beams are generally parallel and the gap is substantially uniform.

The tool 600 may be made of metal such as aluminum although a suitable plastic material such as polyamide may be used. It is only necessary that the device possess sufficient rigidity to perform the contemplated functions yet possess some flexibility to permit positioning of an end in operative relation to the coupling tube as will be explained.

Each platform 605 includes an insertion prong 608 at its free end adjacent rear surface 604. A lifting tooth 610 on each prong 608 has a thickness from rear surface 604 that is slightly less than the width of slot 561 between rim 560 and radial lips 530 of, for example, verifier 500 and 500a or 500b. Each lifting tooth 610 forms a hook 609 at a free end thereof. The hooks 609 aid in improving retention of the slot 561 when the release tool 600 is engaged around a verifier, by increasing the span of retention between the release tool and verifier, angularly, to more than 180 degrees.

Transversely outward from each tooth 610 is an engagement web 612 of somewhat greater transverse thickness from rear surface 604. Each tooth 610 and web 612 define a pocket arranged to receive one of the radial lips 530 of verifier 500, 500a, or 500b. The facing surfaces 614 of the webs 612 are spaced apart about the same distance as the diameter of the verifier 500, 500a, or 500b, across radial lips 530. Thus, the operative end of tool 600 may be engaged with the verifier 500, 500a, or 500b by insertion of the lifting teeth 610 of prongs 608 into slot 561. Because of the spacing of facing surfaces 614 maintained by protrusions 607, this insertion process is readily accomplished without the need to spread the handle beams 601.

Since the prongs 608 are located in opposing facing relation, they are positioned such that lifting teeth 610 engage opposing radial lips 530. When the tool 600 is engaged with the verifier 500, 500a, or 500b, as shown in FIGS. 22 and 23, the webs 612 surround the outer ends of the radial lips 530 that are 180° apart with the lips 530 resting within the pockets formed by the teeth 610 and webs 612. Thus, removal effort is exerted uniformly to slide verifier 500, 500a, or 500b, in a direction 636 that is parallel to the longitudinal extent of tube 420, as shown in FIG. 22.

The release tool 600 additionally includes a retainer release sleeve generally designated 620. It extends perpendicular to the planar surfaces of platforms 605 in a direction toward front surface 603. Though essentially cylindrical, sleeve 620 is bisected by gap 606. The gap 606 and the resilient nature of the flexure portion 602 permit the release sleeve component to be positioned in surrounding relation to the surface 425 of tube 420 of male member 412, as shown in FIG. 24.

The release sleeve 620 is generally a discontinuous cylindrical element formed of identical arcuate segments 622. Each arcuate segment includes an interior semi-cylindrical wall surface 626 formed on a diameter about the same as the outer diameter of outer surface 425 of tube 420. The segments 622 are adapted to reside on the tube outer surface 425 and slide axially relative to the tube along the direction 636.

Exterior semi-cylindrical wall surfaces 628 are formed on a diameter that is generally the same or slightly larger than the outer diameter of upset 422. The segments include chamfers 629 that extend between the interior semi-cylindrical wall surface 626 and exterior semi-cylindrical wall surface 628. These chamfers act as cams to deform the flexure portion 602 to permit placement of the semi-cylindrical segments 622 in surrounding relation to outer surface 425 of tube 420.

The intervening wall between surfaces 626 and 628 is of a thickness such that when inserted into retainer 416 between the surface 425 of tube 420 and interior ramped surfaces 488 of locking arms 476, the locking arms are deformed radially outward sufficiently to permit axial rearward passage of upset 422 out of bore 430 of component 414. As shown in FIG. 24, the release sleeve 620 may be inserted through the clearance area remaining at the opening 432 after retainer 416 has been installed, by sliding along the outer surface 425 of the tube 420. After the release sleeve 620 is in contact with the locking arms 476, additional motion of the sleeve 620 toward the locking arms 476 causes deformation and outward deflection of the locking arms 476 until the abutment surfaces 478 become clear of the upset 422. The axial length of segments 622 is sufficient to permit such insertion with the handle beams 601 disposed immediately rearward of protrusions 481 of retainer 416.

The distal, or free ends of segments 622 include chamfer 630. Chamfer 630 permits the distal ends to accommodate any taper or conical configuration of the upset 422 and ensures association of the outer surface 628 of the segments with the outer diametrical surface of the upset 422 to permit axial withdrawal from under locking arms 476.

Segments 622 each include semi-circular base portions 632 that integrally connect the segments to the planar platform 605. The outer diametrical surface 634 of base portion 632 is formed on a diameter that is slidably received within internal cylindrical surface 463 of ring 456 of retainer 416. This relationship stabilizes the retainer ring 456 during any tube removal operation. The base portions 632 define a gap spacing designated “X” adjacent the joinder of prongs 608 to planar platforms 605. The dimension of the gap 606 at “X” is sized to permit passage of the tube 420 without causing flexure of the handle beams 601. The beams 601 commence to spread when entrance chamfers 629 contact surface 425 of tube 420. Once the tube enters the interior of the sleeve defined by interior semi-cylindrical wall surfaces 626, the handles move toward each other because of the resilient nature of the flexure portion 602. Abutment of protrusion 607 with the side wall of opposing platform 605 prevents excessive clamping pressure being exerted on the tube 420 which would resist sliding of the sleeve segments 622.

A quick connector coupling assembly such as shown in FIG. 1 is coupled together by retainer 416 with locking arms 476. Insertion verifier 500, 500a, or 500b is inserted into retainer 416 with legs 504 and 505 disposed within slots 466 between locking arms 476. Latching surfaces 514 on pads 510 of locking legs 504 releasably engage end surfaces 468 defining rearward terminus of slots 466.

Release tool 600 is suitable to disassemble the male member 412 from component 414. With the plane of front and rear wall surfaces 603 and 604 of the tool generally perpendicular to the axis of bore 430, and rear wall surface 604 facing entrance opening 432, the insertion prongs 608 are engaged with slot 561 of verifier 500a or 500b, as shown in FIGS. 22 and 23. Lifting teeth 610 are disposed under opposing radial lips 530. The lips 530 are cradled within the pockets defined by facing surfaces 614.

The tool is urged axially rearward along the tube 420 in the direction 636 away from the component 414. Application of force sufficient to cause latching surfaces 514 to disengage end surfaces 468 of slots 466 results in axial rearward sliding of verifier 500a along tube 420 out of retainer 416. The verifier 500a or 500 b may remain engaged with the tool 600 after removal from the tube 420, as shown in FIG. 23.

Once the verifier 500 is removed from the retainer 416 access is available to the annulus or clearance at the opening 432 between the outer cylindrical surface 425 of tube 420 and the inner cylindrical surface 463 of ring 456 of retainer 416. Tool 600 is positioned with front wall surface 603 facing toward entrance opening 432, as shown in FIG. 24. Release sleeve 620 extends toward retainer 416. The flexible nature of the flexure portion 602 connecting handle beams 601 permits the handle beams to spread and open gap 606 to permit sleeve 620 to be positioned with internal surfaces 626 in sliding relation to tube surface 425. The tool is urged transversely of tube 420 to cause chamfers 629 to contact outer surface 425 of tube 420. Continued pressure causes the beams to spread apart and segments 622 to surround surface 425 of tube 420. The handle beams 601 are then parallel, and the gap 606 uniform with interior semi-cylindrical surfaces 626 overlying outer cylindrical surface 425 of the tube 420.

The tool 600 is generally perpendicular to tube 420. It is moved axially rearward along the tube to insert exterior semi-cylindrical surface 628 under interior ramped surfaces 488 and urge the locking arms 476 radially outwardly an amount sufficient to permit withdrawal of upset 422 and consequently tube 420.

Notably, the gap 606 at the segments 622 is sufficiently small to permit the release sleeve 620 to contact the interior ramped surfaces 488 of each locking arm 476. It is only necessary that the gap provides access for the entrance of tube 420 into the bore defined by internal semi-cylindrical surfaces 626.

It should also be noted that insertion of verifier 500, 500a, or 500b into a retainer such as retainer 416 is accomplished within ergonomic guidelines. That is, the axial force necessary to insert the legs 504 and 505 within slots 466 between side surfaces 467 of locking arms 476 is less than fifteen (15) pounds. However, the relationship of latching surfaces 514 and end surfaces 468 of slots 466 is such that the force holding the verifier in place exceeds fifteen (15) pounds. The release tool 600 is therefore of valuable assistance to permit effective release of the verifier to effect withdrawal by application of the requisite axial removal force.

Various features of the prior art have been described with reference to the above illustrative embodiments. It should be understood that modifications may be made without departing from the spirit and scope of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A release tool for disengaging a quick connector assembly from a locked into an unlocked position, comprising:
a handle having a generally elongate U-shape defining two handle beams joined at a first end thereof by a flexure portion, said handle forming a gap at a second end thereof opposite said flexure portion;
a semi-cylindrical arcuate member disposed adjacent said second end of each of said two handle beams, said semi-cylindrical arcuate members together forming a generally cylindrical release sleeve, when said release tool is in a closed position, said release sleeve being bisected by said gap when said release tool is in an open position;
an insertion prong disposed at said second end of each of said two handle beams, said insertion prongs extending parallel to one another, when said release tool is in said closed position, and defining a pocket therebetween.

2. The release tool of claim 1, wherein said quick connector assembly is arranged to include a male tubular member having a tube diameter and an upset formed at a free end thereof that is arranged for insertion into a bore formed in a component, a retainer having locking arms disposed in the bore, said locking arms extending radially inwardly to abut the upset and forming slots therebetween, said quick connector assembly further including a verifier having locking legs axially extending from a ring forming an annular slot, said locking legs disposed in the slots between said locking arms in the bore in abutting relationship to said upset.

3. The release tool of claim 2, wherein said pocket of said release tool is adapted to engage said slot formed in said verifier when said release tool is in said closed position around said male tubular member, wherein said release tool is adapted to disengage said locking arms from said retainer when an axial force is applied to said annular slot by said release tool in a direction away from the bore.

4. The release tool of claim 3, further including a hook formed at a free end of each of said insertion prongs, wherein said pocket is defined over a segment surrounding said slot that spans over 180 degrees around said slot.

5. The release tool of claim 2, wherein said release sleeve of said release tool is adapted for insertion into a clearance between said bore and said male tubular member when said locking arms of said retainer abut said upset, and wherein said release sleeve defines an inner cylindrical surface having an inner diameter that is larger than an outer diameter of said upset such that said male member is slidable within said release sleeve when said release tool is in said closed position around said tubular member.

6. The release tool of claim 5, wherein said release sleeve is arranged to engage and radially outwardly deflect said locking arms of said retainer to disengage said abutment between said locking arms and said upset when said release tool is in the closed position around said tubular member and when an axial force is applied to said release tool in a direction toward said bore.

7. The release tool of claim 2, wherein said handle defines a front planar surface and a rear planar surface parallel to said front planar surface, wherein said release sleeve extends perpendicular to said front and rear planar surfaces, and wherein said insertion prongs are coplanar with one another and extend parallel to said first and second planar surfaces.

8. The release tool of claim 7, wherein said insertion prongs are disposed adjacent to said rear planar surface.

9. The release tool of claim 1, wherein said insertion prong forms a tooth at a free end thereof, and a pocket and a mid-section thereof defining a ledge having a thickness that is less than a thickness of said insertion prong, said tooth and said ledge defining a web that is adapted to engage a radially extending wall defined on a verifier of said quick connector assembly.

10. The release tool of claim 1, further including an inwardly sloped chamfer formed at a free end of each semi-cylindrical arcuate member.

11. The release tool of claim 1, further including an outwardly sloped chamfer formed along a straight edge of said semi-cylindrical arcuate member facing said second end of said release tool, said outwardly sloped chamfer adapted to cam along an outer cylindrical surface of a male tubular member of said quick connector assembly during insertion of said release tool around said male tubular member.

12. The release tool of claim 1, further including a planar platform formed on each handle beam, and a protrusion formed on an inside face of said planar platform, wherein the two said inside faces of said planar platforms are disposed opposite one another, and wherein said protrusions are arranged to contact an opposing one of said planar inside faces to define said gap when said release tool is in said closed position.

13. A method for disassembling a quick connector coupling disposed to fluidly connect a male tubular member forming an upset with a bore formed in a component, the quick connector coupling further including a retainer having locking arms disposed in said bore and extending radially inwardly toward said male tubular member in abutting relationship with said upset, the method comprising:
inserting segments of a release sleeve formed on a release tool having a handle around a segment of said male tubular member, said release sleeve being generally cylindrical and having a free end disposed toward said upset of said male tubular member when said release sleeve is inserted around said male tubular member;
moving said release tool axially along said male tubular member such that at least a portion of said release sleeve enters into said bore and contacts said locking arms;
deforming said locking arms in a radially outward direction relative to said bore by applying a force in said axial direction onto said release tool;
removing said male tubular member from said bore after said locking arms have been deformed to an extent that said abutting relationship between said locking arms and said upset has been cleared; and
removing said release sleeve from said bore.

14. The method of claim 13, wherein said quick connector coupling further includes a verifier including a ring forming an annular slot and a plurality of locking legs connected to said ring and extending in said bore in abutting relationship to said upset, wherein said method further comprises:
engaging said annular slot within a pocket formed between two prongs extending parallel to one another from a free end of said release tool when said release tool is in a closed position around said male tubular member; and
disengaging said abutment between said locking legs and said upset by applying a force tending to pull said verifier along said male tubular member in a direction away from said bore.

15. The method of claim 14, wherein said method further includes removing said verifier from said male tubular member by passing a segment of said male tubular member through an open segment formed in said ring of said verifier.

16. A fluid coupling assembly associated with a tube forming an upset close to an end thereof, said fluid coupling assembly comprising:
a connector body defining a bore extending axially from an entrance opening defined by a radially inward extending rim, said bore having a retainer receiving portion adjacent said rim and a sealing member receiving portion forward of said retainer receiving portion;
a retainer releasably secured to said connector body and including a plurality of axially extending locking arms extending into said retainer receiving portion of said bore, each of said plurality of axially extending arms including a rearward abutment surface in abutting relation with said rim, and a forward abutment surface adapted to abut said upset of said tube;
wherein said retainer includes a ring, said rim of said ring bore disposed radially outward of said ring, and said axially extending locking arms extend from said ring into said retainer receiving portion, said locking arms include side faces defining slots between said locking arms terminating in end surfaces; and
an insertion verifier including:
a ring,
a plurality of forwardly extending legs connected to the ring and disposed in said slots defined by said side walls of said locking arms when said insertion verifier is in a locked position relative to said retainer,
a radially outwardly directed pad formed on at least one of said forwardly extending legs and having a rearward end defining a latching surface releasably engaging an end of one of said slots, and
an open segment extending through said ring between two adjacent legs of said plurality of forwardly extending legs, said open segment adapted to accommodate installation of said ring of said insertion verifier around said tube.

17. The fluid coupling assembly of claim 16, wherein said retainer further includes a plurality of rearwardly directed guide elements, each said guide element defined by two angled rearwardly converging surfaces that meet at an apex.

18. The fluid coupling assembly of claim 17, wherein said ring includes radial protrusions between said guide elements, said protrusions defining a channel with said rearward abutment surfaces of said locking arms and said rim is disposed in said channel.

19. The fluid coupling assembly of claim 16, wherein said insertion verifier includes at least a second leg having a radially extending block formed therein adjacent the distal end thereof.

20. The fluid coupling assembly of claim 16, wherein said ring has a central axis of symmetry, and wherein said open segment spans over a ninety degree segment of a circle having a center displaced by a distance from the central axis of symmetry.

21. The fluid coupling assembly of claim 20, further including two radially extending surfaces defined in said ring on either side of said open segment, wherein said two radially extending surfaces are coplanar with radially directed axially extending side walls defined on said two adjacent legs.

22. The fluid coupling assembly of claim 16, wherein said verifier includes two legs each having a radial pad defining a latching surface and two legs having a radially extending block formed thereon.

23. The fluid coupling assembly of claim 22, wherein said pads further include a forward rotational guide defined by two angled guide surfaces converging forwardly and meeting at an apex.

24. The fluid coupling assembly of claim 23, wherein said retainer includes a plurality of rearwardly directed guide elements, each said guide element is defined by two angled rearwardly converging surfaces that meet at an apex, wherein said ring of said verifier includes a radially inner annular wall and a radially outer annular wall connected by a rearward radial annular wall, said legs extending axially forwardly from said radially inner annular wall, said rearward annular wall including angled wall surfaces complementary to said angled surfaces of said guide elements of said retainer and defining pockets receiving said guide elements.

25. The fluid coupling assembly of claim 16, wherein one of said two adjacent legs of said insertion verifier includes a radially extending block formed therein adjacent the distal end thereof.

26. The fluid coupling assembly of claim 16, wherein said retainer includes a plurality of rearwardly directed guide elements, each said guide element is defined by two angled rearwardly converging surfaces that meet at an apex, ring of said verifier includes a radially inner annular wall and a radially outer annular wall connected by a rearward radial annular wall, said legs extending axially forwardly from said radially inner annular wall, said rearward annular wall including angled wall surfaces complementary to said angled surfaces of said guide elements of said retainer and defining pockets receiving said guide elements.
